(19) United States
(12) Patent Application Publication
(10) Pub. No.: US 2015/0302884 A1
(43) Pub. Date: Oct. 22, 2015

(54) APPARATUS AND METHOD OF MULTI-BIT AND GRAY-SCALE HIGH DENSITY DATA STORAGE

(71) Applicants: Steven D. Miller, Richland, WA (US); David W. Gotthold, Richland, WA (US); Jun Cui, Richland, WA (US); Gordon L. Graff, West Richland, WA (US); Bradley R. Johnson, Richland, WA (US)

(72) Inventors: Steven D. Miller, Richland, WA (US); David W. Gotthold, Richland, WA (US); Jun Cui, Richland, WA (US); Gordon L. Graff, West Richland, WA (US); Bradley R. Johnson, Richland, WA (US)

(73) Assignee: BATTELLE MEMORIAL INSTITUTE, Richland, WA (US)

(21) Appl. No.: 14/687,679

(22) Filed: Apr. 15, 2015

Related U.S. Application Data
(60) Provisional application No. 61/981,518, filed on Apr. 18, 2014.

(51) Int. Cl. G11B 7/127; G11B 7/131

(52) U.S. Cl. CPC G11B 7/127; G11B 7/131

(57) ABSTRACT

A data storage apparatus and method of storing data are disclosed. An array of irradiation sources are provided for writing on an optically stimulated luminescence (OSL) material. The OSL material includes data storage pixels or spots. Each pixel or spot includes gray-scale levels with higher order bits and variable intensity. A light source stimulates luminescence on the OSL material.

### CROSS-REFERENCE TO RELATED APPLICATIONS

This application claims priority to U.S. Provisional Application Ser. No. 61/981,518, filed Apr. 18, 2014, titled “APPARATUS AND METHOD OF MULTI-BIT AND GRAY-SCALE HIGH DENSITY DATA STORAGE,” hereby incorporated by reference in its entirety for all of its teachings.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### TECHNICAL FIELD

This invention relates to data storage reading and writing devices and methods. More specifically, this invention relates to an apparatus and method of multi-bit and/or gray-scale high density data storage using optically stimulated luminescence (OSL) encoding technology.

### BACKGROUND

In the past, Cathode Ray Tube (CRT) electron guns were used to raster scan the TV phosphors in old TV sets to create the pictures. A small CRT-style e-gun would be used at low voltage and would dwell longer on data storage pixels that needed more bits of information than other pixels with lower exposure requirements. The issue with this slow serial approach is that it would take a very long time to encode a realistic OSL data disk, especially for archival data storage that is currently viewed as a viable target market for an OSL data disk.

With the ever increasing need for data storage density and data archiving, including the recognized crisis looming for magnetic data storage technology reaching the end of its product cycle (magnetic materials have reached the fundamental limit as to the smallest size for a data pixel), other technologies are needed to continue the process towards ever increasing data storage densities.

### SUMMARY

The present invention is directed to methods and apparatuses for storing data. In one embodiment, a data storage apparatus is disclosed. The apparatus includes an array of irradiation sources or writing on an optically stimulated luminescence (OSL) material; and a light source for stimulating luminescence on the OSL material. A voltage may be applied between the emitter tips and the OSL material.

The apparatus may further include a photodiode for absorbing and converting the light to electrical signals.

The array of irradiation sources may comprises a dense array of emitter tips.

In one embodiment, the emitter tips are isolated and spaced apart from the array of irradiation sources

In one embodiment, the apparatus may further comprise a multiplexer for communicating with each emitter tip separately.

The OSL material includes a plurality of data storage pixels or spots. Each pixel or spot includes a plurality of gray-scale levels with higher order bits and variable intensity.

In one embodiment, the array of irradiation sources generates a stepwise increase in intensity of each pixel or spot.

In one embodiment, the array of irradiation sources is a carbon nanostructured array. In another embodiment, the array generates X-rays.

The writing may be performed in a vacuum.

In one embodiment, the OSL material is an OSL rotatable disk.

The light source is, but not limited to, blue laser light or Blu-Ray violet light.

In another embodiment of the present invention, a method of storing data is disclosed. The method includes providing an array of irradiation sources for writing on an OSL material; and stimulating luminescence on the OSL material using a light source.

The method may further include applying a voltage between the array and the OSL material, and absorbing and converting the light to electrical signals.

In another embodiment of the present invention, a method of storing data is disclosed. The method includes irradiating an OSL media, which produces a plurality of data storage pixels or spots. Each pixel or spot includes a plurality of gray-scale levels with higher order bits and variable intensity. The method also includes stimulating luminescence on the OSL media using light. The method may further include generating a stepwise increase in intensity of each pixel or spot.

In another embodiment of the present invention, an apparatus for storing data is disclosed. The apparatus includes an electron emission source for recording on a rotatable OSL disk. The apparatus also includes a plurality of data storage pixels or spots on the OSL disk. Each pixel or spot includes a plurality of gray-scale levels with higher order bits and variable intensity. The apparatus further includes a light source for stimulating luminescence on the OSL disk.

In one embodiment, the apparatus further includes a photodiode for converting absorbed photons off the OSL disk into electrical signals, and a decoder for converting the electrical signals into words.

In one embodiment, the OSL disk includes a coating of LiF nanoparticles. In one embodiment, the nanoparticles are between around 50 nm and 300 nm. The nanoparticle coatings can include carbon nanoparticle additives to enhance the OSL data pixel readout.

The additives may be carbon black or other additives. The additives absorb or reflect away all light that does not get emitted by an OSL data pixel being read out by the light source.

### BRIEF DESCRIPTION OF THE DRAWINGS

FIG. 1 is a schematic diagram of an array of irradiation source for electron beam writing on a disk, in accordance with one embodiment of the present invention.

FIG. 2 is an exploded view of an electron beam emitter, etched out of a silicon chip, for electron beam writing on a disk, in accordance with one embodiment of the present invention.

FIG. 3 is a schematic diagram of a data storage apparatus for reading from a disk, in accordance with one embodiment of the present invention.

FIG. 4 is a schematic diagram of a data storage apparatus for writing on a disk, in accordance with one embodiment of the present invention.

FIG. 5 is a dose response graph of change in intensity of luminescence with dose emitted from the irradiating sources, obtained by plotting the emitted dose along the X-axis and the change in intensity of luminescence along the Y-axis.

FIG. 6 is a top view of multi-level encoding acquired by SEM for writing patterned boxes, with nine distinct green emission levels or gradations observed.

FIG. 7 is a dose response graph of change in intensity of luminescence with dose and number of electrons emitted from the irradiating doses, obtained by plotting the emitted dose and number of electrons along the X-axis and the change in intensity of luminescence—showing a stepwise increase in intensity—along the Y-axis.

### DETAILED DESCRIPTION OF THE PREFERRED EMBODIMENTS

The following description includes the preferred best mode of embodiments of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

The present invention includes methods and apparatuses that provide higher data density storage devices. In one aspect of the invention, data structures are encoded into OSL data storage materials to enable electron-beam writing of multi-bit encoding, also known as gray-scale encoding, into OSL data storage media. A light source shines light on the OSL media, which stimulates luminescence, for reading the small pixels or spots on the OSL media.

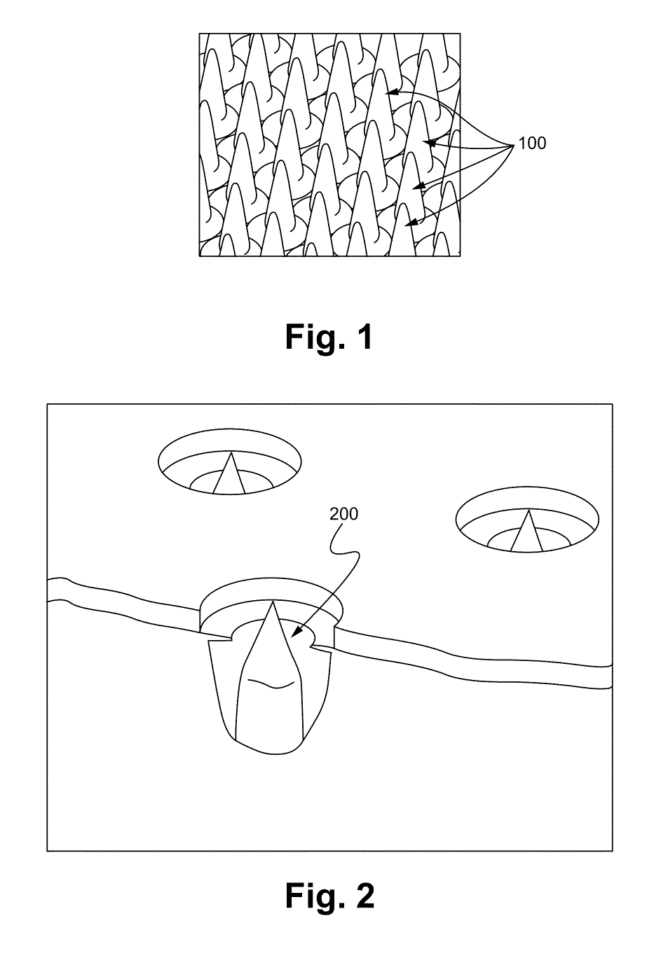

In one embodiment, an array of irradiation sources is used for electron-beam writing on the OSL material. As shown in FIG. 1, the irradiation sources may be a dense array of field-effect emitters 100. The emitter may be made of, but not limited to, silicon.

The silicon-based emitters are very small structures that can be mass produced with modern computer chip etch fabrication, MEMS, and silicon computer/memory chip processing techniques.

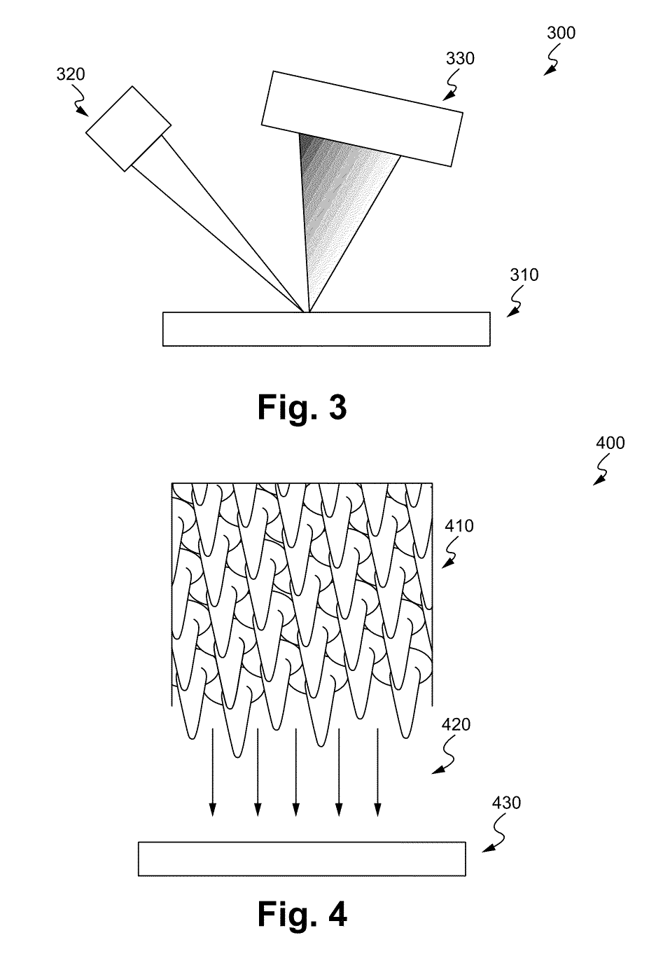

In one embodiment, as shown in FIG. 2, the basic structure of the emitter 200 is a cone of Silicon and the cone necks down to a very fine tip that is on the order of tens of nanometers (nm), or smaller. When the silicon structure is biased with even a relatively low voltage, the gap between the Silicon tip and the media or receiver structure is so narrow that the electric fields between the gap are quite large. The breakdown voltage is easily reached with modest voltages.

Large arrays of the very microscopic Silicon-based Field-Effect emitters or tips can be economically manufactured using modern processing techniques. The large number of arrays of very fine tipped Silicon electron emitters are even capable of encoding BluRay sized OSL pixels or smaller.

The small Silicon tips can be as small as 10 nm or smaller at the very tip of the emitter. The present invention can include large arrays of these Silicon emitter tips of around 10-100 by 100 to 1000, or greater. If each small Silicon tip is biased to several hundred volts or even 1000 volts or more then each silicon tip could write “1×” of dose. In one embodiment, once a given OSL pixel has stepped through all 1000 increments, then one more OSL pixel is written each single time increment. Each time the emitter array moves to the next pixel, there is a unit dose write process completed. By the time the array moves across 100 pixels, the first OSL data storage pixel would have a dose written from a grayscale of “0” to “99”. This massively parallel write approach would enable much faster encoding speeds compared to just one electron beam writer. An array length of 1000 could be possible as well, even if 10 Field-Effect arrays of 100 emitters were used in series. Then a grayscale value of “000” to “999” would be possible. The move speeds and modulating of the currents should be considered as part of any practical encoding system.

As another example, emitter arrays of hundreds to thousands of small electron emitters, with each emitter biased at 500-1000 volts, would be one way to enable the OSL media for achieving encoding speeds of Giga-bits per second.

Blue laser light can be used for reading, but it is not the only color that can be used to readout the light stimulated from the OSL material. BluRay violet can work as well. A series of excitation and emission spectra in irradiated LiF (OSL material) shows that LiF can be excited from blue side of greenish down to violet and also down to near-UV. Changes to the excitation wavelength also change the LiF OSL emission spectra quite profoundly.

FIG. 3 is a schematic diagram of a data storage apparatus 300 for reading from a disk, in accordance with one embodiment of the present invention. The apparatus 300 includes an OSL plate 310, a light source 320, and a photodiode 330. The photodiode 330 absorbs photons off the OSL plate and converts the photons to electrical signals.

FIG. 4 is a schematic diagram of a data storage apparatus 400 for writing on an OSL disk 430, in accordance with one embodiment of the present invention. The apparatus 400 includes an array of irradiation sources 410, which emit electrons 420 or generate an electric field when a voltage is applied between the array 410 and the OSL disk 430.

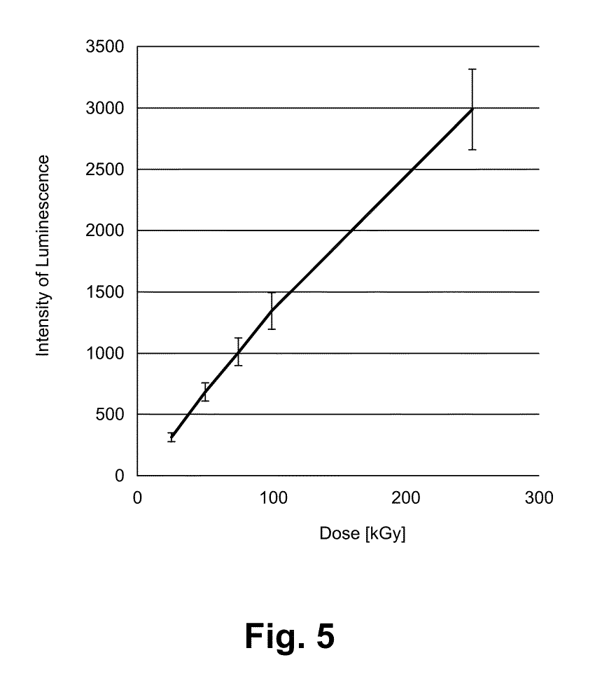

FIG. 5 is a dose response graph of change in intensity of luminescence with dose emitted from the irradiating sources, obtained by plotting the emitted dose along the X-axis and the change in intensity of luminescence along the Y-axis. As shown in FIG. 5, the present invention enables very dense OSL pixels. Depending on the radiation dose applied—or number of electrons emitted by the array of irradiation sources—each spot or pixel on the OSL media can store multiple bits, with different intensity gradations. By using a variable intensity electron beam, each pixel or spot can include a plurality of gray-scale levels with higher order bits.

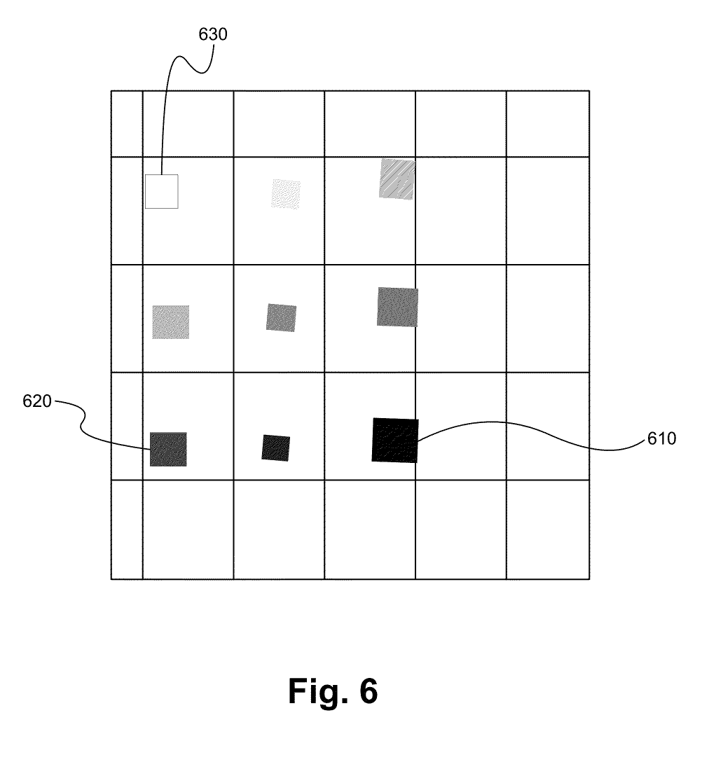

FIG. 6 is a top view of multi-level encoding acquired by SEM for writing patterned boxes, with nine distinct green emission levels or gradations observed. As shown in the FIG. 6, some of the pixels have more intensity and brightness than the other pixels. Pattern 610, for example, is brighter than pattern 620, and pattern 620 is even brighter than pattern 630.

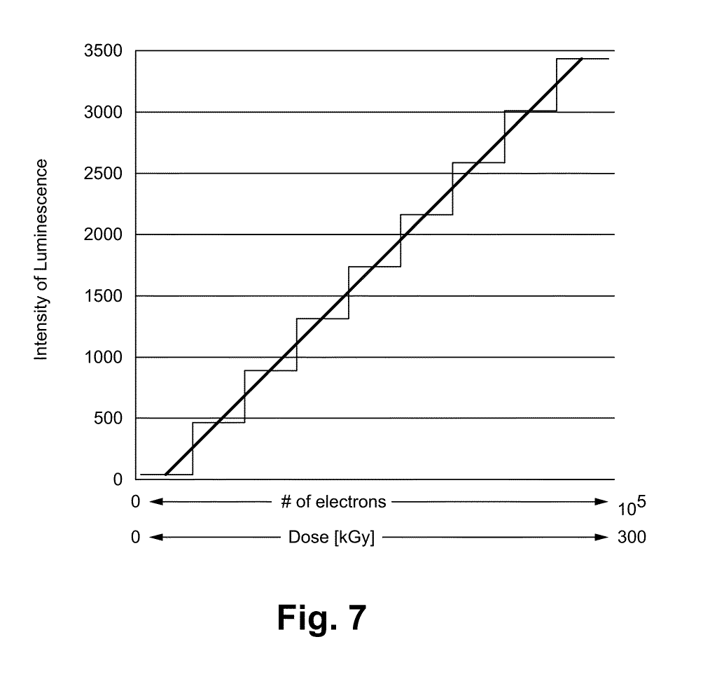

FIG. 7 is a dose response graph, similar to FIG. 6, of change in intensity of luminescence with dose and number of electrons emitted from the irradiating doses, obtained by plotting the emitted dose and number of electrons along the X-axis and the change in intensity of luminescence—showing a stepwise increase in intensity—along the Y-axis.

FIG. 7 shows a stepwise increase in intensity, with multiple levels, of each pixel or spot. The different levels correspond to the number of bits of information stored in each pixel or spot. For example, 2 bits corresponds to 4 levels, 3 bits corresponds to 8 levels, 4 bits corresponds to 16 levels, and 5 bits corresponds to 32 levels, and so on. For a “deeper” grayscale encoding, 8 to 12 bits per pixel, corresponding to 256 to 4096 levels, can be resolved.

The OSL media can include various coatings and/or additives. In one embodiment, a high density OSL media includes a coating of LiF nanoparticles, where the nanoparticles are between around 50 nm and 300 nm.

High density OSL nanoparticle coatings can include carbon nanoparticles or other non-OSL additives that will enhance the OSL data pixel readout. Additives to the OSL nanoparticles can absorb or reflect away any OSL light emissions that are caused by neighboring OSL data pixels. When the OSL data pixel is illuminated to excite the OSL emission process, it is possible that OSL data pixels neighboring the OSL pixel currently being readout will either a) receive a little of the stray excitation light, or some reflected light will strike the neighboring pixels as part of the readout, or the OSL excitation light beam is just a little too large in diameter to only illuminate the OSL data pixel of interest, or b) its possible due to the speed of the readout and/or some longer-lived persistence of the OSL emission process that the neighboring pixel might still be emitting some OSL emission light. By adding carbon black or other additives this can create a much more favorable measurement of an individual OSL data pixel by absorbing or reflecting away all OSL emission light or stray OSL emission light, and even background fluorescence to a degree that does not get emitted directly on top of the OSL pixel being readout. The additives, which strongly absorb or reflect away all light that does not get emitted by the OSL data pixel being readout, can be built into the OSL media by design in the fabrication of the OSL data disks. Thus, the OSL pixel readout light will be emitted straight into the light detector, resulting in an OSL disk that strongly absorbs or reflects light that is not originating from the OSL pixel being readout. Another way to accomplish this is to add polarization properties to the optical filters or coatings on the small photodiodes or small light detectors that quantify the OSL emission. The coatings will reject light that does not reach the detector in a normal degree of incidence.

The coatings are high speed enough to permit economical mass production of OSL data disks, and the coating method is capable of creating large concentrations of “F-centers”. A thin film coating method is capable of adding small concentrations of dopant cations (i.e. Mg+, Ca++, Ti++, etc.) where the dopants create higher OSL emission as a function of ionizing radiation dose and shifts in the excitation and emission spectra of the OSL properties. Shifts in the excitation and emission spectra can enable higher signal-to-noise performance and shift the properties enough to align better with commercial lasers or light sources for the excitation process, and better detection for commercial solid state light detectors. Higher concentrations of F-centers and altered OSL properties also can enhance the near-UV and visible light encoding techniques.

A pure alpha emitter or equivalent, which can be combined with a strong electro-magnetic field, can re-direct the alpha emissions going in all directions and create a small alpha encoder to encode the OSL data pixel.

A suitable solvent can be used with the OSL media by spin casting onto a substrate to obtain a uniform, smooth coating. Micelles can be created that are rich in LiF, an OSL material, which can be surrounded by a polymeric matrix—cells and cell walls in a close-pack array. The size and density of the LiF micelles can be controlled to achieve the degree needed.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A data storage apparatus comprising:
a. an array of irradiation sources for writing on an optically stimulated luminescence (OSL) material; and
b. a light source for stimulating luminescence on the OSL material.

2. The apparatus of claim 1 further comprising a photodiode for absorbing and converting the light to electrical signals.

3. The apparatus of claim 1 wherein the array of irradiation sources comprises an array of emitter tips.

4. The apparatus of claim 3 wherein a voltage is applied between the emitter tips and the OSL material.

5. The apparatus of claim 3 wherein the emitter tips are isolated and spaced apart about 5 to 500 nm from one another.

6. The apparatus of claim 3 further comprising a multiplexer for communicating with each emitter tip separately.

7. The apparatus of claim 1 wherein the OSL material includes a plurality of data storage pixels or spots.

8. The apparatus of claim 7 wherein each pixel or spot includes a plurality of gray-scale levels with higher order bits and variable intensity.

9. The apparatus of claim 8 wherein the array of irradiation sources generates a stepwise increase in intensity of each pixel or spot.

10. The apparatus of claim 1 wherein the array of irradiation sources is a carbon nanostructured array.

11. The apparatus of claim 1 wherein the array of irradiation sources generates X-rays.

12. The apparatus of claim 1 wherein the writing is performed in a vacuum.

13. The apparatus of claim 1 wherein the OSL material is an OSL rotatable disk.

14. The apparatus of claim 1 wherein the light source is a blue laser light or a BluRay violet light.

15. A method of storing data comprising:
a. providing an array of irradiation sources for writing on an OSL material; and
b. stimulating luminescence on the OSL material using a light source.

16. The method of claim 15 further comprising absorbing and converting the light to electrical signals.

17. The method of claim 15 wherein the array of irradiation sources comprises an array of emitter tips.

18. The method of claim 17 further comprising applying a voltage between the emitter tips and the OSL material.

19. The method of claim 17 further comprising isolating the emitter tips from the array and spacing apart the emitter tips about 5 to 500 nm from one another.

20. The method of claim 17 further comprising communicating with each tip separately.

21. The method of claim 15 wherein the OSL material includes a plurality of data storage pixels or spots.

22. The method of claim 21 wherein each pixel or spot includes a plurality of gray-scale levels with higher order bits and variable intensity.

23. The method of claim 22 wherein the array of irradiation sources generates a stepwise increase in intensity of each pixel or spot.

24. The method of claim 15 wherein the writing is performed in a vacuum.

25. The method of claim 15 wherein the array of irradiation sources generates X-rays.

26. The method of claim 15 wherein the OSL material is an OSL rotatable disk.

27. A method of storing data comprising:
a. irradiating an OSL media, which produces a plurality of data storage pixels or spots, wherein each pixel or spot includes a plurality of gray-scale levels with higher order bits and variable intensity; and
b. stimulating luminescence on the OSL media using light.

28. The method of claim 27 further comprising generating a stepwise increase in intensity of each pixel or spot.

29. The method of claim 27 wherein the OSL media includes at least one of the following: powders, nano-powders, and thin coatings.

30. An apparatus for storing data comprising:
a. an electron emission source for recording on a rotatable OSL disk;
b. a plurality of data storage pixels or spots on the OSL disk, wherein each pixel or spot includes a plurality of gray-scale levels with higher order bits and variable intensity; and
c. a light source for stimulating luminescence on the OSL disk.

31. The apparatus of claim 30 further comprising a photodiode for converting absorbed photons off the OSL disk into electrical signals.

32. The apparatus of claim 31 further comprising a decoder for converting the electrical signals into words.

33. The apparatus of claim 30 wherein the light source is a blue laser light or a BluRay violet light.

34. The apparatus of claim 30 wherein the OLS disk includes a coating of LiF nanoparticles, wherein the nanoparticles are between around 50 nm and 300 nm.

35. The apparatus of claim 34 wherein the nanoparticle coatings include carbon nanoparticle additives to enhance the OSL data pixel readout.

36. The apparatus of claim 35 wherein the additives are carbon black.

37. The apparatus of claim 36 wherein the additives absorb or reflect away all light that does not get emitted by an OSL data pixel being read out by the light source.
